(19) United States
(12) Patent Application Publication
(10) Pub. No.: US 2014/0118528 A1
(43) Pub. Date: May 1, 2014

(54) SETTING UNIT AND METHOD FOR SETTING A SEQUENCE FOR THE AUTOMATIC RECORDING OF IMAGES OF AN OBJECT BY MEANS OF A RECORDING DEVICE, AND RECORDING DEVICE HAVING SUCH A SETTING UNIT

(71) Applicant: Carl Zeiss Microscopy GmbH, Jena (DE)

(72) Inventors: Horst Wolff, Siegenburg (DE); Daniel Svejdar, Kirchdorf (DE); Markus Eichinger, Tuerkenfeld (DE); Sebastian Albrecht, Muenchen (DE); Moritz Ringler, Muenchen (DE); Helmut Zöphel, Hallbergmoos (DE)

(73) Assignee: Carl Zeiss Microscopy GmbH, Jena (DE)

(21) Appl. No.: 14/065,030

(22) Filed: Oct. 28, 2013

(30) Foreign Application Priority Data
Oct. 29, 2012 (DE) DE102012219775.3

(51) Int. Cl. G02B 21/36

(52) U.S. Cl. CPC G02B 21/365
USPC 348/79

(57) ABSTRACT

A setting unit for sequencing automatic recording of images with a recording device. The setting unit provides a first input interface via which a recording program can be set, provides a second input interface via which at least one parameter, which is to be monitored during the execution of the sequence, is proposed and can be selected in dependence on the recording program, provides a third input interface via which at least one condition, and at least one action upon fulfilment of the condition, can be set for the parameter, and generates control data for the control module.

### RELATED APPLICATION

The present application claims priority to German Application No. 102012219775.3 filed Oct. 29, 2012, said application being hereby incorporated herein by reference in its entirety.

### FIELD OF THE INVENTION

The present invention relates to a setting unit and a method for setting a sequence for the automatic recording of images of an object by means of a recording device, and to a recording device having such a setting unit.

### BACKGROUND OF THE INVENTION

Recording devices such as, for example, a microscope, are often used for performing complex experiments. An experiment sequence may include differing recording dimensions (time, dimension in x-, y- and z-direction, colours and contrasts, etc.) defined by the user, before commencement of the experiment, by means of a setting unit. In addition, before the start of the experiment, the user can define such experiment settings for recording that are then later executed automatically. Thus, a time interval or the entire recording duration (or the number of time points) of a time series can be defined. It is also possible to define a plurality of positions on the specimen in the x-, y- and z-direction (spatially), a range in the x-, y- and/or z-direction in which the sample is scanned during image recording, fixed illumination times and/or laser intensity or LED intensity for differing recording channels.

Despite these definitions for the experiment sequence, this is still an experiment sequence that is rigid, and therefore fully defined, before the start of the experiment, and that is increasingly unsuitable to make image recordings for present-day research or routine investigations. Thus, basically, the user is confronted with the fact that, on the one hand, it is not possible to reliably predict at the start of the experiment (particularly in the case of living samples) how the sample will behave during the course of the experiment. For example, the sample may move out of the defined image field, vary in intensity or, upon an external stimulus, react with a variation in shape, position or other characteristics. On the other hand, the user often has a fixed concept of which sample conditions are to affect recording in which manner, but is unable to implement this concept with the existing hardware and software or through the user's own capabilities.

This can have the result that the pre-set experiment, or the pre-set sequence does not proceed in an ideal manner (in the sense of scientific or technical information relating to the sample), that the user him/herself must spend a large amount of time on the system in order to effect interactions, and/or that the capacity in the recording of sample images is low.

### SUMMARY OF THE INVENTION

Proceeding from this, an object of embodiments of the invention is to provide a setting unit, for setting a sequence for the automatic recording of images of an object by means of a recording device, which setting unit can be used to set a sequence that, when executed, removes the problems described at the outset. In addition, a corresponding method is provided for setting a sequence for the automatic recording of images of the object by means of a recording device, and a recording device having such a setting unit.

According to embodiments of the invention, the object is achieved by a setting unit by means of which it is possible to set a sequence for the automatic recording of images of an object by means of a recording device, which has a sample stage for carrying the object, a digital recording unit for recording the object, and a control module for controlling the recording device for the purpose of executing the sequence, wherein the setting unit is realized in such a manner that it executes the following steps:
a) providing a first input interface via which a recording program can be set,
b) providing a second input interface via which at least one parameter, which is to be monitored during the execution of the sequence, is proposed and can be selected in dependence on the recording program set in step a),
c) providing a third input interface via which at least one condition, and at least one action upon fulfilment of the condition, can be set for the parameter selected in step b),
d) generating control data for the control module, which describe the sequence on the basis of the inputs in steps a)-c).

The provision of steps b) and c) makes it possible to select and set parameters, or observables, and associated conditions and actions, that enable the sequence (e.g. of an experiment) to be monitored continuously, wherein this is effected automatically as the sequence is executed.In particular, the user can still be offered an accustomed graphical environment in which, as formerly, the user can define the recording program. Now, however, in steps b) and c) the user is additionally offered the possibility of selecting a parameter together with an associated condition and action, thereby enabling the sequence to be monitored continuously as it is being executed, or enabling feedback to be implemented.

Advantageous developments of the setting unit according to embodiments of the invention are specified in the dependent claims. In particular, the setting unit can be realized in such a manner that a function that can be selected in step c) as the at least one action can be added through integration of a program describing the function. The program is, in particular, a script that is formulated in a script language such as, for example, Python, or as a macro. The action that can be added, for example, as an integrated program, may be, in particular, the invocation of other, independent programs and the transfer of program parameters to the latter, and/or provision of information to the user (e.g. in acoustic, textual and/or graphical form). In addition, the action may be the initiation of a trigger event.

In addition, the setting unit can be realized in such a manner that the at least one parameter proposed in step b) is an image analysis parameter (such as, for example, the image brightness), an environmental parameter (such as, for example, the temperature of the sample or of its environment), a state parameter of the recording device (e.g. the sample stage position), and/or a state parameter of the sequence (for example, the presence of a step of the sequence). The setting unit may be realized, in particular, as hardware and software.

Furthermore, it is possible for a control module for controlling the recording device to be integrated with the setting unit, at least partially.

Embodiments of the invention may include a recording device (in particular, a microscope system) for the automatic recording of images of an object according to a sequence, wherein the recording device has:
a sample stage for carrying the object,
a digital recording unit for recording the object,
a control module for controlling the recording device for the purpose of executing the sequence, and
a setting unit according to embodiments of the invention (including developments thereof according to the invention), wherein, following execution of step d), the setting unit transfers the control data to the control module for the purpose of executing the sequence.

Embodiments of the invention may include a method for setting a sequence for the automatic recording of images of an object by means of a recording device that has a sample stage for carrying the object, a digital recording unit for recording the object, and a control module for controlling the recording device for the purpose of executing the sequence, comprising the steps:
a) providing a first input interface via which a recording program can be set,
b) providing a second input interface via which at least one parameter, which is to be monitored during the execution of the sequence, is proposed and can be selected in dependence on the recording program set in step a),
c) providing a third input interface via which at least one condition, and at least one action upon fulfilment of the condition, can be set for the parameter selected in step b),
d) generating control data for the control module, which describe the sequence on the basis of the inputs in steps a)-c).

It will be appreciated that the features mentioned above and those yet to be explained in the following are applicable, not only in the stated combinations, but also in other combinations or singly, without departure from the scope of the present invention.

### BRIEF DESCRIPTION OF THE DRAWINGS

The invention is explained by way of example in yet more detail in the following with reference to the appended drawings, which also disclose features of the invention. There are shown in:

FIG. 1 is a schematic view of a setting unit 1 according to the invention, together with a recording device 2, realized as a microscope; and

FIG. 2 is a flow diagram to explain the steps provided by the setting unit according to the invention.

### DETAILED DESCRIPTION OF THE DRAWINGS

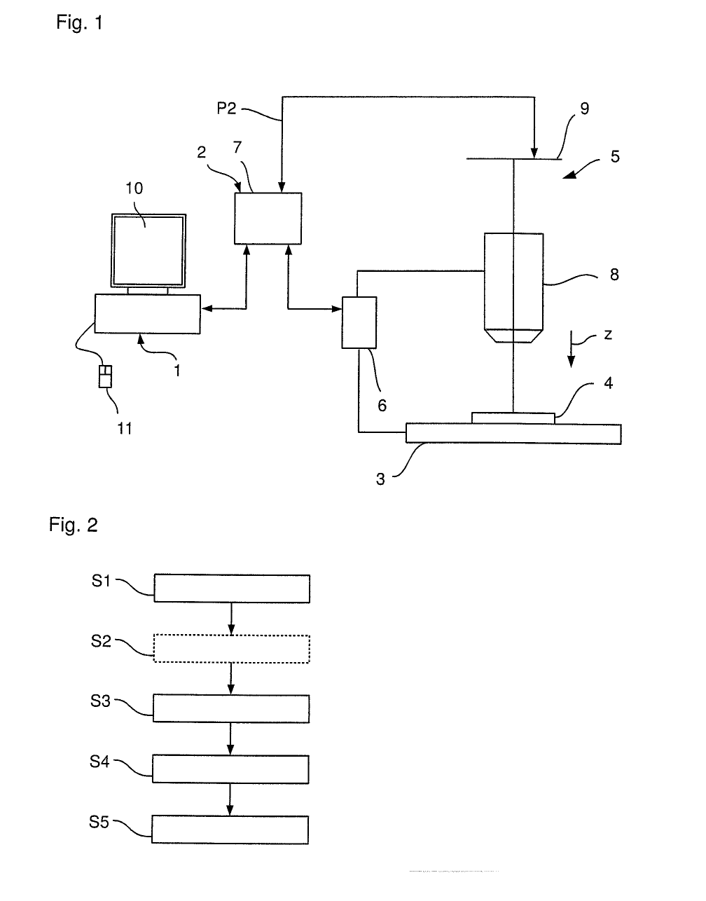

In the case of the embodiment depicted in FIG. 1, a setting unit 1 according to the invention, and a recording device 2, realized as microscope, are shown schematically. Recording device 2 generally includes a sample stage 3 carrying a sample 4, a digital recording unit 5, a movement unit 6, and a control module 7. Recording unit 5 includes imaging optics 8 and a digital camera 9 that can record a magnified image of part of sample 4, generated through imaging optics 8. Movement unit 6 is realized such that it can alter the distance (along a z-direction) between imaging optics 8 and sample stage 3, and consequently sample 4, and/or the position of sample stage 3 relative to the position of imaging optics 8, in a plane perpendicular to the z-direction. The alteration of distance in the z-direction makes it possible to set differing focal positions or imaging positions, and an alteration of position in the plane perpendicular to the z-direction can be used to approach a particular lateral position of the sample 4.

Recording device 2, under the control of control module 7, can perform a predetermined sequence (e.g. experiment sequence) for the automatic recording of images of the object. The setting unit 1 according to the invention can be used to set the predetermined experiment sequence, as described in detail in the following.

The setting unit 1 can be realized as a conventional computer, and have a monitor screen 10, and an input unit 11, which is represented schematically in FIG. 1 as a computer mouse. The input unit 11 can additionally or alternatively comprise a keyboard or other operating interface. Furthermore it is possible, additionally or alternatively, for the monitor screen 10 itself to be realized as input unit 11. For example, the monitor screen 10 can be touch-sensitive.

The setting unit 1 is then realized in such a manner that it executes the steps described in the following in connection with FIG. 2. A recording program that is to be executed (e.g. a measurement program) is set in step S1. For this purpose, various recording programs, which are selectable by a user, can be offered via the monitor screen 10. In this case, it is possible to select as a recording program, for example, a time series in which a recording of the sample 4 at predetermined intervals of time is created. It is also possible to set, as a recording program, the recording of a z-image stack of images from predetermined z-planes of the object. The corresponding displays on the monitor screens 10, together with the input unit 11, can be referred to as a first input interface. The subsequent step S2 is optional, and is described at a later point.

In step S3, a plurality of parameters to be monitored during the execution of the experiment sequence, are proposed to the user via the monitor screen 10. These parameters can also be referred to as observables. The proposed parameters in this case are such parameters that are appropriate in respect of the recording device 2 for which the experiment sequence is to be predetermined, and in respect of the recording program selected in step S1. In particular, the setting unit 1 can include or access a database, table or other collection of data that specifies, for the parameters that can be proposed, the recording program, from step S1, and the type of recording device 2 for which they are suitable. In step S3, therefore, only the appropriate parameters can be proposed, which increases clarity in selection. This proposal of parameters can be realized by means of a macro or script language environment, and can also be referred to as the provision of a second input interface.

In step S4, a third input interface (by means of a monitor screen 10 and an input unit 11) is then provided, via which it is possible to select a condition for the parameter(s) selected in step S3, and at least one action upon fulfilment of the condition. In this case, conditions and actions, insofar as appropriate, can also be proposed at the same time (at least to some extent). Thus, for example, a mathematical comparison can be proposed (such as, for example, greater than, less than, etc.), wherein the comparison value is freely selectable. In this case, there is partial proposal.

Steps S3 and S4 can also be combined with each other, as a joint step. Thus, for example, when a parameter is proposed, corresponding conditions and actions upon fulfilment of the conditions can also be proposed at the same time. For steps S1, S3 and S4, either a purely graphical user interface, a text-based interface (in particular, text-based programming) or a mixture thereof can be provided, via the monitor screen 10.

The parameters from step S3 can describe, for example, the environment, or ambient conditions (for example, parameters of the control module 7, such as time, memory location of the destination drive, etc.), the state of the experiment sequence (e.g. expired time, current z-plane, etc.) and/or the hardware state of the recording device 2 or devices connected thereto (e.g. incubation temperature, trigger-signal input, etc.). Furthermore, the parameters can be, or include, image analysis parameters such as, for example, the number of objects in the image, the surface area of the objects, the position of objects, etc.

In step S5, the setting unit 1 generates control data, for the control module 7, which describe the predetermined experiment sequence on the basis of the inputs in steps S1, S3 and S4. These control data are then transferred to the control module 7, which, with the recording device 2, executes the predetermined experiment sequence on the basis of the control data.

In addition to the execution of the desired recording program (according to step S1), therefore, a monitoring of the experiment, as was defined in steps S3 and S4, is also performed. The monitoring of the experiment can thus also be referred to as a feedback function, such that the experiment sequence is no longer rigid. There can be an automatic reaction to changes that occur during the course of the experiment.

As parameters, it is possible to define, for example, the number of objects and/or the density of the cells (in the image field) over the period of time. It is also possible to define as a parameter, for example, a number of cells in a tiled image comprising a plurality of individual images. The condition is then that of whether the number of objects or the density attains or exceeds a definable value. Upon the defined value being attained or exceeded, the experiment sequence may be stopped, information provided, or another action initiated.

Moreover, an object than can grow and/or move can be defined as a parameter. As a condition, it is possible to define, for example, that the object always be contained in its entirety in the recording, and if this condition is not met, that the recording settings are to be altered (e.g. by adjustment of the lateral position of the sample stage 3, the z-position of the focal position and/or by adjustment of the magnification of the imaging optics 8) such that the object can again be recorded in its entirety. In this way, a moving object can be tracked.

Moreover, the illumination time and/or the illumination intensity can be defined as parameters. As a condition, it is possible to define, for example, minimum or maximum values of these parameters, or properties to be attained by the already created recordings (which properties are determined, for example, in continuous analyses of these recordings). Then, as an action, these parameters can be adjusted for particular recording channels.

Moreover, as an action, it is possible to define or adjust a region (position, shape, size, intensity) for a photo manipulation in a sample on the basis of the analysis (condition) of a previously recorded image stack, a time series, or a tiled image, with respect to, for example, an image parameter. It is also possible for the images of a time series to be analyzed continuously, and for the results (analysis values, time stamps, etc.) to be stored (e.g. continuously) in a file. At the end of the experiment sequence, the analysis of the entire time series has already been completed, and the data are available in a file, e.g. in a standard format (for example .txt or .csv).

It is possible to search (at low magnification) a large image field, having a plurality of individual image recordings, for a particular event, and then to alter the recording parameters (e.g. increased magnification) and thereby make a new recording of the event. User-defined hardware can also be controlled in the experiment sequence by invocation of external programs created by the user.

In step S2, it is optionally possible to define an analysis program, which is used to determine at least one parameter to be measured for the recordings that are to be made. This can be effected, in particular, on the basis of typical images, like those to be recorded in the subsequent experiment sequence.

The setting unit 1 according to the invention can generate control data for any kind of recording device and, in particular, for any kind of microscope system. The microscope system may be realized both as an upright and as an inverse system. It is also possible for the microscope system to be realized as a stereo microscope, as a wide-field system or as a system for optical sections. Even in the case of microscope systems in which the sample stage 3 cannot be moved by motor drive relative to the imaging optics 8, the setting unit 1 according to the invention can generate corresponding control data. Thus, for example, the experiment sequence can be stopped, as an action, if a predetermined number of objects (parameter) is attained over the period of time (condition). The setting unit 1 can be part of the recording device 2.

A standard script language such as, for example, Python, can be used for defining the parameters, defining conditions and actions, and for other calculations. The scripts can be manually created and edited by the user, or created automatically by the setting unit 1. In the input interfaces, it is possible to present graphical selection elements that can be selected, for example, by a single click, and then to add previously produced, executable script parts to the experiment sequence.

The definition of the parameters, conditions and actions is a constituent part of the whole predetermined experiment sequence, and can be stored together with the associated recording program, and reloaded. The definition is stored with the experiment (it contains all information for restoration).

The script for monitoring the parameters and implementing the actions can run asynchronously or in a synchronized manner at the same time as the actual recordings. The preferred variant is asynchronous running (i.e. accompanying the execution of the recordings), because this does not result in the execution of the recordings being stopped or disrupted. The monitoring of the parameters therefore runs in parallel with the creation of the recording. The system analyzes the images according to the dimensions as they were defined in the recording program. If, for example, the recording program was created for an individual two-dimensional image, then, after each recorded two-dimensional image, a check is performed in respect of the changes to the parameters. If the recording program was defined for a z-stack, completion of the z-stack is awaited and a check is then performed in respect of changing parameters. This is set automatically, such that this need not be defined in addition by the user. For the user, this reduces the amount of work. If the parameters (or their values) have changed, they are then preferably matched to the conditions.

Analysis programs can be used to generate features that can be used as parameters and that can be monitored. Preferably, only the parameters that are offered by the selected recording program, or that are appropriate for the latter, are available in step S3. This avoids the use of non-existing or inappropriate parameters.

Additional functions can be realized through integration of programs such as, for example, scripts and/or macros (only the term script is used in the following). It is possible to provide a predefined selection of actions, from which the user can select and parameterize one or more. In particular, these actions can include the invocation of other, independent programs (.exe) and the transfer of program parameters to the latter. Such program parameters may be, for example, command-line parameters such as, for example, the file path to an image file, thereby enabling an external image analysis program to analyze an image just recorded, while the experiment sequence continues to be executed. It is additionally possible for information to be provided to the user, e.g. via email or SMS, if a condition is attained, such as, for example, that the experiment is completed or that it is awaiting input by the user.

In addition, trigger events can be initiated. It is possible for experiment parameters (e.g. the illumination time, stage position, etc.) to be changed, predefined experiments to be controlled in a specific manner, and values to be written into a file. Reports can be generated, stating which parameters have changed, and in what manner, during the sequence, and which actions have resulted therefrom.

The script can be converted (according to predefined rules) into a graphical view, and can be displayed, for example, via the monitor screen 10, and can undergo further graphical processing and be converted back into a script. Aspects of functionality can be activated or deactivated through a single parameter. It can be indicated, during the experiment sequence, whether or not the feedback is active. The generated script can be validated in respect of correct syntax and function (following confirmation by the user). The user interface can offer documented examples for scripts, which can be immediately adopted and, if necessary, altered.

During the recording, continuous contents, parameters, recording and/or measurement results can be written into a file (either added to an existing file or written into a new file). The file can be read by the setting unit itself or by external programs. The file can even be opened automatically in an external (third) program and used when the file path is transferred, as a parameter, into this external program.

This functionality can also be used to extend the possibilities in the case of offline measurements or evaluations (measurements or evaluations following completion of image recording) of images that have already been recorded (measurement or evaluation data relating to image dimensions can be written into a file).

1. A setting unit adapted to sequence a recording device to automatically record images of an object, the recording device including a sample stage for carrying the object, a digital recording unit for recording the object, and a control module for controlling the recording device to execute the sequence, the setting unit comprising a processor programmed with an algorithm for performing the following steps:
a) presenting a first input interface through which a recording program is specified;
b) presenting a second input interface through which at least one parameter to be monitored during the execution of the sequence is proposed and selected, said at least one parameter depending on the recording program specified in step a);
c) presenting a third input interface through which at least one condition, and at least one action to be performed upon fulfillment of the condition, are specified for the at least one parameter selected in step b); and
d) generating control data for the control module, the control data describing the sequence on the basis of the inputs in steps a)-c).

2. The setting unit of claim 1, wherein the at least one action of step c) is specified through an algorithm describing the action.

3. The setting unit of claim 1, wherein the at least one parameter proposed in step b) is an image analysis parameter, an environmental parameter, a state parameter of the recording device, or a state parameter of the sequence.

4. The setting unit of claim 1, wherein the at least one parameter proposed step b) depends on the recording device specified in step a).

5. The setting unit of claim 1, wherein the algorithm further comprises presenting a fourth input interface through which an analysis algorithm is specified, the analysis algorithm being used to determine the at least one parameter proposed in step b).

6. The setting unit of claim 1, wherein a predefined selection of parameters is proposed in step b).

7. The setting unit of claim 1, wherein the definition of the selected parameter, the selected condition and the selected action are stored, together with a definition of the specified recording program.

8. The setting unit of claim 1, wherein a predefined selection of actions is proposed in step c).

9. The setting unit of claim 1, wherein, based on the at least one parameter, the at least one condition, and the at least one action, the setting unit generates a script, and presents the script in a graphical view for further processing or alteration.

10. The setting unit of claim 1, wherein the control data generated in step d) are presented in a report, the report stating which parameter has changed and in what manner during the sequence.

11. The setting unit of claim 1, wherein the control data generated in step d) include contents of the recordings, parameters, evaluation or measurement results, and the control data are continuously written into a file.

12. The setting unit of claim 1, wherein monitoring of the at least one parameter is effected without interruption of the recording of the images.

13. The setting unit of claim 1, wherein the control data are generated in step d) such that, in execution of the sequence based the control data, an analysis of image data is performed in the same dimension in which the image data are created.

14. A recording device for the automatic recording of images of an object according to a sequence, the device comprising:
a sample stage for carrying the object;
a digital recording unit for recording the object;
a control module for controlling the recording device to execute the sequence; and
a setting unit comprising a processor programmed with an algorithm for performing the following steps:
a) presenting a first input interface through which a recording program is specified;
b) presenting a second input interface through which at least one parameter to be monitored during the execution of the sequence is proposed and selected, said at least one parameter depending on the recording program specified in step a);
c) presenting a third input interface through which at least one condition, and at least one action to be performed upon fulfillment of the condition, are specified for the at least one parameter selected in step b); and
d) generating control data for the control module, the control data describing the sequence on the basis of the inputs in steps a)-c).

15. A method for setting a sequence for automatic recording of images of an object by a recording device, the recording device having a sample stage for carrying the object, a digital recording unit for recording the object, and a control module for controlling the recording device for the purpose of executing the sequence, the method comprising:
a) providing a first input interface via which a recording program can be set;
b) providing a second input interface via which at least one parameter, which is to be monitored during the execution of the sequence, is proposed and can be selected in dependence on the recording program set in step a);
c) providing a third input interface via which at least one condition, and at least one action upon fulfilment of the condition, can be set for the parameter selected in step b); and
d) generating control data for the control module, which describe the sequence on the basis of the inputs in steps a)-c).
